(19) United States
(12) Patent Application Publication
(10) Pub. No.: US 2005/0225990 A1
(43) Pub. Date: Oct. 13, 2005

(54) Tree support and light display apparatus

(76) Inventor: D. Austin Kirk, Williamsburg, VA (US)

Correspondence Address: S. Michael Bender, P.O. Box 530399, St. Petersburg, FL, 33747, US

(21) Appl. No.: 10/819,582

(22) Filed: Apr. 7, 2004

(51) Int. Cl. F21V 15/00; F21V 7/04; F21V 5/00; F21V 17/00; F21S 4/00

(52) U.S. Cl. 362/362

(57) ABSTRACT

A tree support and light display apparatus includes a housing which includes a top housing portion and side housing portions which support the top housing portion. The housing includes an open side. An illumination unit is received in the housing through the open side. The top housing portion includes a tree-trunk-reception well and light-exit openings. Preferably, the illumination unit includes a drawer portion, and a light emission assembly is received in the drawer portion. The open side of the housing includes a drawer lock member. The drawer lock member engages a complementary lock engaging portion on the bottom of the drawer portion. Light from the illumination unit shines through the light-exit openings to shine upon a tree supported by the tree-trunk-reception well.

### BACKGROUND OF THE INVENTION

1. Field of the Invention

The present invention relates generally to support stands for Christmas trees and the like and, more particularly, to Christmas tree support stands that are especially adapted for illuminating the Christmas tree.

2. Description of the Prior Art

Christmas trees are often decorated with ornaments. In addition, to enhance their beauty, Christmas trees are often illuminated. A first mode of illumination is to provide decorative lights that are supported by branches of the tree. A second mode of illumination is to provide a support stand for the Christmas tree that contains a source of illumination.

With respect to the second mode of illumination, throughout the years, a number of innovations have been developed, and the following U.S. patents are representative of some of those innovations: U.S. Pat. Nos. 3,766,376, 5,829,863, 6,050,714, and 6,438,879. More specifically, each of U.S. Pat. Nos. 3,766,376, 5,829,863, and 6,050,714 discloses a stand that supports a Christmas tree that includes optical fibers therein. In each respective tree support stand, a source of illumination is present and a motor-rotatable color wheel is present. Variable colors are directed from the motor-rotatable color wheel to the optical fibers for distribution of the colored light throughout the Christmas tree. Two important observations are made about the tree illumination devices disclosed in U.S. Pat. Nos. 3,766,376, 5,829,863, and 6,050,714. First, the illumination devices are used only with trees that have optical fibers. Second, the respective sources of illumination and the respective color wheels are contained in respective housings whose interior housing spaces are difficult to access. With respect to the first observation, most existing Christmas trees do not employ optical fibers. In this respect, it would be desirable if a tree support and light display apparatus were provided that supports and illuminates trees that do not employ optical fibers. With respect to the second observation, there may be times when it would be desirable to change or service a color wheel, a source of illumination, or a motor driving the color wheel. In this respect, it would be desirable if a tree support and light display apparatus were provided that included easy access to an interior housing space so that it would be easy to change or service a color wheel, a source of illumination, or a motor driving the color wheel.

U.S. Pat. No. 6,438,879 discloses an illuminated stand for a Christmas tree, wherein the Christmas tree does not have to include optical fibers. A tree is supported on a ceiling panel of the housing which houses a color wheel, a source of illumination, and a motor driving the color wheel. Once the tree is supported on the stand, if it is either desirable or necessary to service or change the color wheel, the source of illumination, or the motor driving the color wheel, then the ceiling panel has to be removed from the remainder of the housing, and the tree has to removed from the remainder of the housing also. Thus, a great deal of effort must be expended simply to gain access the inside of the housing to service or change the color wheel, the source of illumination, or the motor driving the color wheel. In this respect, it would be desirable if a tree support and light display apparatus were provided which does not require a housing ceiling panel to be removed and does not require a supported tree to be moved in order to access the interior contents of the housing in order to service or change the color wheel, the source of illumination, or the motor driving the color wheel

U.S. Pat. No. 6,102,556 may be of interest for its disclosure of a detachable light filter holder.

Thus, while the foregoing body of prior art indicates it to be well known to use illuminated stands for Christmas trees, the prior art described above does not teach or suggest a tree support and light display apparatus which has the following combination of desirable features: (1) supports and illuminates trees that do not employ optical fibers; (2) provides easy access to an interior housing space so that it would be easy to change or service a color wheel, a source of illumination, or a motor driving the color wheel; and (3) does not require a housing ceiling panel to be removed and does not require a supported tree to be moved in order to access the interior contents of the housing in order to service or change the color wheel, the source of illumination, or the motor driving the color wheel. The foregoing desired characteristics are provided by the unique tree support and light display apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a tree support and light display apparatus that includes a housing which includes a top housing portion and side housing portions which support the top housing portion. The housing includes an open side. An illumination unit is received in the housing through the open side. The top housing portion includes a tree-trunk-reception well and light-exit openings. Light from the illumination unit shines through the light-exit openings to shine upon a tree supported by the tree-trunk-reception well.

Preferably, the tree-trunk-reception well is centrally located in the top housing portion, and the light-exit openings are located circumferentially around the tree-trunk-reception well. Preferably, the illumination unit includes a drawer portion, and a light emission assembly is received in the drawer portion. The open side of the housing includes a drawer lock member. The drawer lock member engages a complementary lock engaging portion on the bottom of the drawer portion.

The light emission assembly includes a source of electrical power. A light assembly is electrically connected to the source of electrical power. An electric motor is electrically connected to the source of electrical power. A spindle is connected to the electric motor, and a color-filter wheel is connected to the spindle. The light assembly and a portion of the color-filter wheel are in registration. The light assembly, the portion of the color-filter wheel, and some of the light-exit openings are in registration when the illumination unit is received in the housing.

The light emission assembly can further include a fan unit that is electrically connected to the source of electrical power. The light emission assembly can further include a motor speed controller that is electrically connected to the electric motor. Preferably, the source of electrical power includes a wire and plug for connection to a source of AC power.

In addition, stabilizer wings can be attached to the housing. Each of the stabilizer wings includes a housing attachment tongue, and the housing includes stabilizer attachment grooves for connecting with the housing attachment tongues.

Preferably, the open side of the housing includes an open-side frame portion, and the illumination unit provides a close fit with the open-side frame portion.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved tree support and light display apparatus which has all of the advantages of the prior art and none of the disadvantages.

It is another object of the present invention to provide a new and improved tree support and light display apparatus which may be easily and efficiently manufactured and marketed.

It is a further object of the present invention to provide a new and improved tree support and light display apparatus which is of durable and reliable construction.

An even further object of the present invention is to provide a new and improved tree support and light display apparatus which is susceptible of a low cost of manufacture with regard to both materials and labor, and which accordingly is then susceptible of low prices of sale to the consuming public, thereby making such tree support and light display apparatus available to the buying public.

Still yet a further object of the present invention is to provide a new and improved tree support and light display apparatus which supports and illuminates trees that do not employ optical fibers.

Still another object of the present invention is to provide a new and improved tree support and light display apparatus that provides easy access to an interior housing space so that it would be easy to change or service a color wheel, a source of illumination, or a motor driving the color wheel.

Yet another object of the present invention is to provide a new and improved tree support and light display apparatus which does not require a housing ceiling panel to be removed and does not require a supported tree to be moved in order to access the interior contents of the housing in order to service or change the color wheel, the source of illumination, or the motor driving the color wheel.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a preferred embodiment of the tree support and light display apparatus of the invention supporting and illuminating a Christmas tree.

FIG. 2 is an enlarged side view of the embodiment of the tree support and light display apparatus shown in FIG. 1, wherein the Christmas tree has been removed from the apparatus.

FIG. 3 is an enlarged cross-sectional view of the embodiment of the tree support and light display apparatus of FIG. 2 taken along line 3-3 thereof.

FIG. 4 is a top view of the embodiment of the invention in FIG. 2 taken along line 4-4 thereof, wherein the interior access drawer has been pulled out, thereby permitting easy access to the color wheel, the source of illumination, and the motor driving the color wheel.

FIG. 5 is a partially exploded perspective view of the embodiment of the invention shown in FIGS. 1-4.

### DESCRIPTION OF THE PREFERRED EMBODIMENT

With reference to the drawings, a new and improved tree support and light display apparatus embodying the principles and concepts of the present invention will be described.

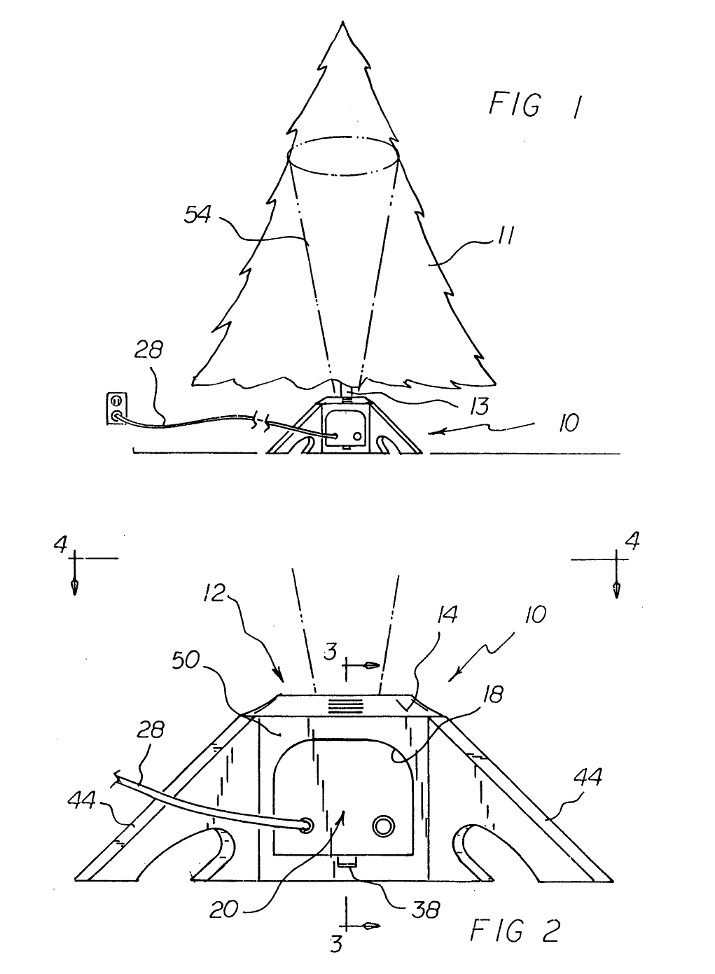

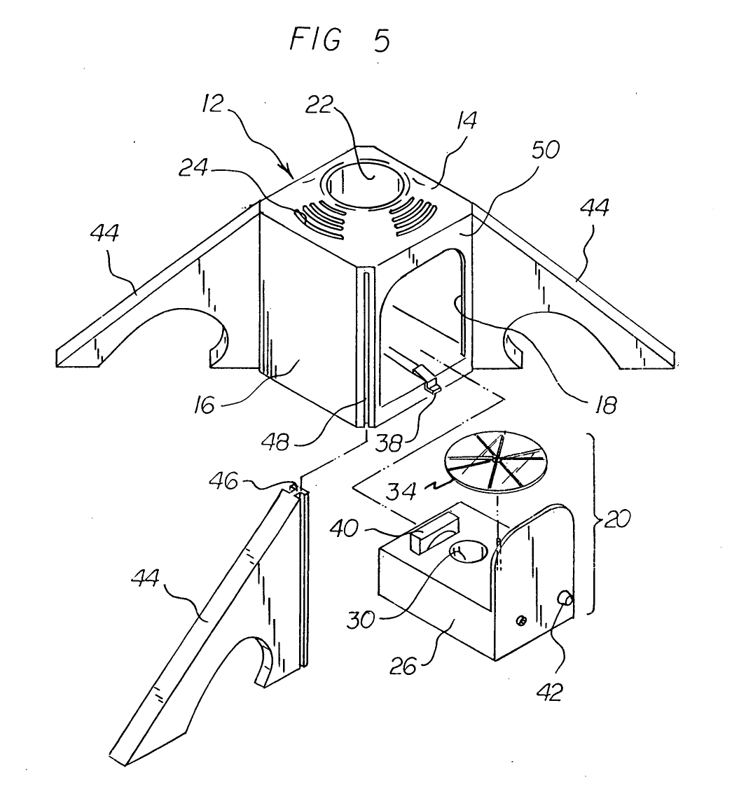

Turning to FIGS. 1-5, there is shown a preferred embodiment of the tree support and light display apparatus of the invention generally designated by reference numeral 10. In the preferred embodiment, a tree support and light display apparatus 10 includes a housing 12 which includes a top housing portion 14 and side housing portions 16 which support the top housing portion 14. The housing 12 includes an open side 18. An illumination unit 20 is received in the housing 12 through the open side 18. The top housing portion 14 includes a tree-trunk-reception well 22 and light-exit openings 24.

Preferably, the tree-trunk-reception well 22 is centrally located in the top housing portion 14, and the light-exit openings 24 are located circumferentially around the tree-trunk-reception well 22. Preferably, the illumination unit 20 includes a drawer portion 26, and a light emission assembly is received in the drawer portion 26. The open side 18 of the housing 12 includes a drawer lock member 38. The drawer lock member 38 engages a complementary lock engaging portion 56 on the bottom of the drawer portion 26.

The light emission assembly includes a source of electrical power. A light assembly 30 is electrically connected to the source of electrical power. An electric motor 32 is electrically connected to the source of electrical power. A spindle 52 is connected to the electric motor 32, and a color-filter wheel 34 is connected to the spindle 52. The light assembly 30 and a portion of the color-filter wheel 34 are in registration. The color-filter wheel 34 has a plurality of differently colored color filter segments distributed around the center of the color-filter wheel 34. The light assembly 30, the portion of the color-filter wheel 34, and some of the light-exit openings 24 are in registration when the illumination unit 20 is received in the housing 12.

The light emission assembly can further include a fan unit 40 that is electrically connected to the source of electrical power. The light emission assembly can further include a motor speed controller 42 that is electrically connected to the electric motor 32. The motor speed controller 42 can be a variable resistor or rheostat. Preferably, the source of electrical power includes a wire and plug 28 for connection to a source of AC power.

In addition, stabilizer wings 44 can be attached to the housing 12. Each of the stabilizer wings 44 includes a housing attachment tongue 46, and the housing 12 includes stabilizer attachment grooves 48 for connecting with the housing attachment tongues 46.

Preferably, the open side 18 of the housing 12 includes an open-side frame portion 50, and the illumination unit 20 provides a close fit with the open-side frame portion 50.

To use the tree support and light display apparatus 10 of the invention, the bottom portion of a tree 11 is placed in the tree-trunk-reception well 22. In this way, the housing 12 supports the tree 11. The stabilizer wings 44 can provide added stability for the housing 12.

As shown in FIGS. 1, 2, and 3, the illumination unit 20 is inserted fully into the housing 12. As a result, when the light assembly 30 is emitting light, a portion of the color-filter wheel 34 is in registration with the light assembly 30, and some of the light-exit openings 24 are in registration with the color-filter wheel 34 and the light assembly 30. When this occurs, light beams 54 emerge from the light-exit openings 24 and shine upon the tree 11, as shown in FIG. 1.

As the color-filter wheel 34 is rotated by the electric motor 32, the light that emerges from the light-exit openings 24 and that lands on the tree 11 changes color. The motor speed controller 42 is used control the speed of the electric motor 32 and thereby controls the rate of rotation of the color-filter wheel 34 and the rate of color change of the light emerging from the light-exit openings 24.

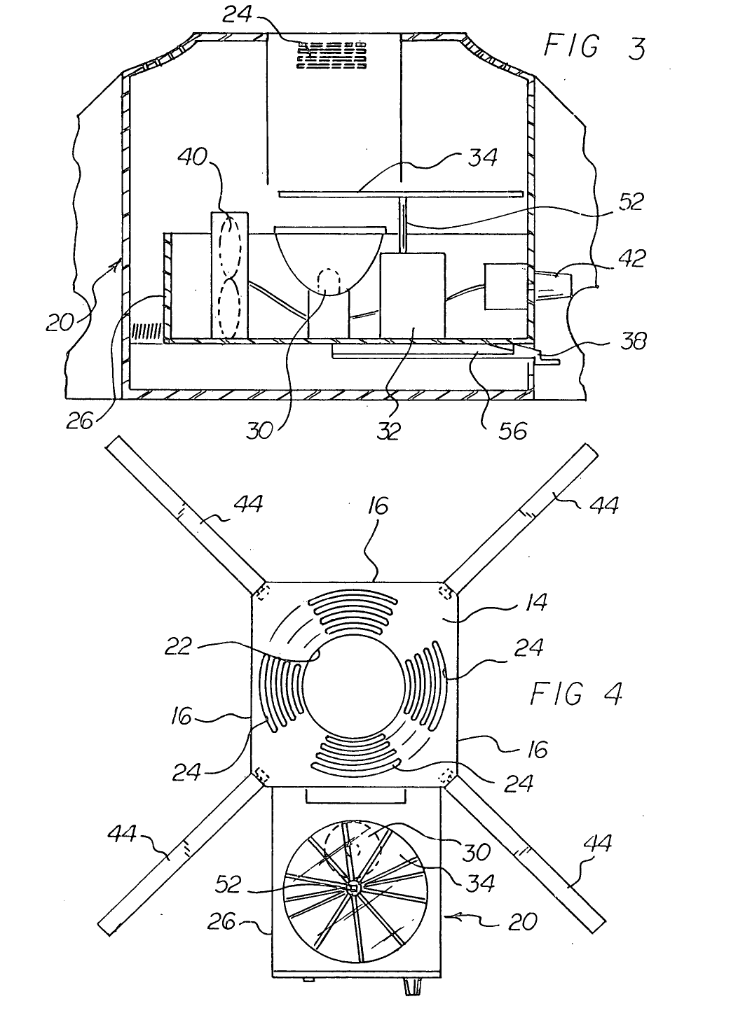

When maintenance or changing of any of the components in the illumination unit 20 is to be done, the drawer lock member 38 is disengaged from the lock engaging portion 56 of the drawer portion 26, and the illumination unit 20 is pulled out from the housing 12, as shown in FIG. 4. To do so, the tree 11 and the support of the tree 11 by the housing 12 is not disturbed.

When the maintenance or the changing of any of the components in the illumination unit 20 has been completed, the illumination unit 20 can be slid back into a close fit in the housing 12, and the drawer lock member 38 re-engages the lock engaging portion 56 of the drawer portion 26.

The components of the tree support and light display apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved tree support and light display apparatus that is low in cost, relatively simple in design and operation, and which may advantageously be used to support and illuminate trees that do not employ optical fibers. With the invention, a tree support and light display apparatus provides easy access to an interior housing space so that it would be easy to change or service a color wheel, a source of illumination, or a motor driving the color wheel. With the invention, a tree support and light display apparatus is provided which does not require a housing ceiling panel to be removed and does not require a supported tree to be moved in order to access the interior contents of the housing in order to service or change the color wheel, the source of illumination, or the motor driving the color wheel.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A tree support and light display apparatus, comprising:
a housing which includes a top housing portion and side housing portions which support said top housing portion, wherein said housing includes an open side, and
an illumination unit received in said housing through said open side.

2. The apparatus of claim 1 wherein said top housing portion includes:
a tree-trunk-reception well, and
light-exit openings.

3. The apparatus of claim 2 wherein:
said tree-trunk-reception well is centrally located in said top housing portion, and
said light-exit openings are located circumferentially around said tree-trunk-reception well.

4. The apparatus of claim 1 wherein said illumination unit includes:
a drawer portion, and
a light emission assembly received in said drawer portion.

5. The apparatus of claim 4 wherein said open side of said housing includes a drawer lock member.

6. The apparatus of claim 4 wherein said drawer portion includes a lock engaging portion for engaging said drawer lock member on said housing 12.

7. The apparatus of claim 4 wherein said light emission assembly includes:
a source of electrical power,
a light assembly electrically connected to said source of electrical power,
an electric motor electrically connected to said source of electrical power,
a spindle connected to said electric motor, and
a color-filter wheel connected to said spindle,
wherein said light assembly and a portion of said color-filter wheel are in registration.

8. The apparatus of claim 7 wherein said light assembly, said portion of said color-filter wheel, and some of said light-exit openings are in registration when said illumination unit is received in said housing.

9. The apparatus of claim 7 wherein said light emission assembly further includes a fan unit electrically connected to said source of electrical power.

10. The apparatus of claim 7 wherein said light emission assembly further includes a motor speed controller electrically connected to said electric motor.

11. The apparatus of claim 7 wherein:
said source of electrical power includes a wire and plug for connection to a source of AC power.

12. The apparatus of claim 1, further including stabilizer wings attached to said housing.

13. The apparatus of claim 12 wherein:
each of said stabilizer wings includes a housing attachment tongue, and
said housing includes stabilizer attachment grooves for connecting with said housing attachment tongues.

14. The apparatus of claim 1 wherein:
said open side includes an open-side frame portion, and
said illumination unit provides a close fit with said open-side frame portion.
